(19) United States
(12) Patent Application Publication
(10) Pub. No.: US 2019/0313649 A1
(43) Pub. Date: Oct. 17, 2019

(54) Baking Device With A Cooled Longitudinal Strut

(71) Applicant: HAAS FOOD EQUIPMENT GMBH, Leobendorf (AT)

(72) Inventors: Johann Sachsenhofer, Wien (AT); Daniel Süss, Tulln an der Donau (AT); Stefan Jiraschek, Königsbrunn (AT)

(73) Assignee: HAAS FOOD EQUIPMENT GMBH, Leobendorf (AT)

(21) Appl. No.: 16/462,043

(22) PCT Filed: Nov. 22, 2017
(86) PCT No.: PCT/EP2017/079994

§ 371 Date: May 17, 2019

(30) Foreign Application Priority Data
Nov. 22, 2016 (EP) 16455006.3

(51) Int. Cl. A21B 1/42; A21B 5/02; A21B 1/26; A21B 3/00

(52) U.S. Cl. CPC A21B 1/42; A21B 3/00; A21B 1/26; A21B 5/023

(57) ABSTRACT

A baking apparatus (1) for producing baked edible products, including a frame (21), a housing (20), a baking chamber (2), and a baking tong chain (3) with baking tongs (8) and rollers (9). The rollers roll on at least one longitudinal strut (10) that supports and/or guides the baking tong chain. A cooling duct (11) through which cooling air flows cools the longitudinal strut. The cooling duct (11) opens in the region of the rear deflection point (6) through at least one convection opening (12) into the baking chamber. A convection fan (25) generates a convection flow in the baking chamber and conveys the cooling air through the cooling duct (11) so that the cooling air flows through the convection opening from the cooling duct to produce an artificial convection, horizontally through the baking chamber.

### CROSS-REFERENCE TO RELATED APPLICATION(S)

This application is the National Stage of International Patent Application No. PCT/EP2017/079994 filed on Nov. 22, 2017, which claims priority from European Patent Application No. 16455006.3 filed on Nov. 22, 2016, both of which are herein incorporated by reference herein in their entireties.

### BACKGROUND

### 1. Field of the Invention

The invention relates to a baking apparatus.

### 2. State of the Art

A plurality of baking apparatuses for producing baked products are known from the prior art. For example, baking apparatuses are known with open baking chambers which comprise outlet openings or nozzles for the exit of a cooling air flow. These nozzles are turned directly to the part of the apparatus to be cooled. By this means, the running rollers, the running roller tracks and/or the lateral wall inner sides can be cooled. Such an apparatus is known, for example, from the Austrian patent specification AT 380 150 B. A disadvantage with conventional baking apparatuses is that the cooling devices negatively influence the flow conditions in the baking chamber. This has the disadvantage that no directional flow is produced in the baking chamber. Baking apparatuses are also known from the prior art which have cooling ducts through which liquid cooling media flow for cooling the longitudinal struts on which the rollers of the baking tongs and/or the baking tong chain roll, wherein these cooling ducts extend in closed form through the baking chamber. A disadvantage with these baking apparatuses is that the cooling medium can only be used for cooling and not synergistically to produce an artificial convection in the baking chamber.

A suitable apparatus for generating uniform convection flows in baking ovens with circulating baking tongs is known, for example, from WO 2015/165 868 A1. Air is introduced from outside into the baking chamber through an inlet opening, wherein the air is preferably pre-heated. At an outlet opening the air can then escape from the baking chamber again, whereby a directional air flow is generated which assists the heat convection.

A person skilled in the art in the field of baking ovens with circulating baking tongs would in no way combine the features of WO 2015/165 868 A1 with a generic apparatus for cooling running rollers and side wall inner sides as is possibly known from AT 380 150 B in order to create a device which generates a directional convection flow in the baking chamber. This is because the person skilled in the art would not be instructed by the technical teachings of the two documents to provide outlet openings of the cooling ducts only in the region of the rear deflection point of the baking tong chain in order to generate a directional convection flow.

### SUMMARY

It is now the object of the invention to overcome the disadvantages of the prior art. In particular it is the object of the invention to provide a baking device which can be manufactured and operated efficiently and which furthermore has an improved lifetime.

The object according to the invention is solved in particular by the hereinafter described features.

By means of the baking apparatus according to the invention, a synergistic effect can be achieved that the longitudinal struts reinforce and/or stiffen the baking apparatus framework, that the cooling air can be used for cooling the longitudinal struts and produce an artificial convection in the baking chamber and that the air used to produce this artificial convection flows into the baking chamber already pre-heated.

In particular, it is an advantage of the invention that a baking apparatus is provided which comprises longitudinal struts cooled by cooling ducts. These longitudinal struts are preferably simply constructed and easy to fabricate. Furthermore, the longitudinal struts are preferably used as stiffening and/or reinforcement of the baking apparatus frame of the baking apparatus. Furthermore, the longitudinal struts should preferably be capable of fastening simply and quickly on the baking apparatus frame.

The invention relates to a baking apparatus for producing baked, preferably edible products, wherein the baking apparatus comprises a baking apparatus frame with a baking apparatus housing and a baking chamber arranged inside the baking apparatus housing, wherein the baking apparatus has an endless baking tong chain which circulates continuously along an inherently closed path and moves through the baking chamber, which chain extends from a front deflection point arranged in a pre-head to a rear deflection point, wherein the baking tong chain comprises coupled-together baking tong carriages with openable and closable, in particular fold-out and fold-in baking tongs, wherein a plurality of rollers are provided on the baking tong chain, wherein the rollers roll at least along a part of the path on at least one longitudinal strut to support and/or guide the baking tong chain, wherein a cooling duct through which cooling air flows is provided for cooling the at least one longitudinal strut.

Optionally it is provided that the cooling duct opens in the region of the rear deflection point through at least one convection opening into the baking chamber, that a convection fan is provided to generate a convection flow in the baking chamber and to convey the cooling air through the cooling duct so that the cooling air flows through the convection opening from the cooling duct of the at least one longitudinal strut to produce an artificial convection, in particular horizontally, through the baking chamber.

By means of the baking apparatus according to the invention, it is possible to use the cooling air which flows through the cooling duct to produce an artificial convection in the baking chamber. According to the invention, it is provided that the cooling air introduced by a fan in the region of the rear deflection point opens into the baking chamber through at least one convection opening of the cooling duct. The cooling air exiting in the baking chamber mixes with the baking chamber gases and flows with these through the baking chamber, in particular from the rear deflection point as far as the pre-head or as far as the vent of the baking apparatus. As a result, the baking chamber gases and the cooling air are mixed in the entire baking chamber and the cooling air generates an artificial convection in the baking chamber. During operation of the baking apparatus, in particular during heating of the baking chamber, the cooling air flowing through the cooling duct is heated. In this case, the cooling duct acts as heat exchanger and heats the cooling air. As a result, it is optionally possible to reduce the required power of the rear air fan used in conventional baking apparatuses. On the other hand, due to the synergistic pre-heating of the cooling air used for convection, the energy consumption of the baking apparatus is reduced. It is thereby possible to operate the baking apparatus more efficiently, in particular more energy-efficiently. Furthermore, due to the cooling of the longitudinal struts, the lifetime of the rollers and/or the bearings of the rollers is increased since due to the cooling the temperature of the rollers and/or the bearings of the rollers is reduced by up to 30° C. Furthermore, the overheating of the rollers and/or the bearings of the rollers which frequently occurs in conventional baking apparatuses is prevented which occurs in particular in the energy saving mode of the baking apparatuses.

Optionally it is provided that the cooling duct extends as far as the convection opening, in particular on the baking chamber side, closed through the baking chamber.

It is thereby possible to make the cooling air exit from the cooling duct in a defined region, in particular in the region of the rear deflection point. Thus, the cooling air can optionally exit from the cooling duct exclusively from the convection openings. The convection openings are optionally provided in the region of the rear deflection point and optionally the cooling duct has no further openings through which cooling air can flow into the baking chamber. In particular, as a result of this defined exit point, an artificial convection of the convection opening is produced, which flows through the baking chamber, in particular horizontally and enables an optimized mixing in the baking chamber.

Optionally it is provided that the convection fan introduces the cooling air through at least one injection opening into the cooling duct, that the at least one injection opening or at least one injection opening is provided at a distance from the convection opening and/or that the at least one injection opening or at least one injection opening is provided in the region of the front deflection point and/or that the at least one injection opening or at least one injection opening is provided in the region of the pre-head and/or that the at least one injection opening or at least one injection opening is provided in the region of a vent opening and/or that the at least one injection opening or at least one injection opening is provided in the region of a dividing wall between pre-head and the baking chamber and/or that the at least one injection opening or at least one injection opening is provided in the region of the baking chamber.

Since the cooling air is optionally introduced into the cooling duct through the injection opening at a distance from the convection opening, it is possible to cool the longitudinal struts, in particular over their entire length. Preferably it can be provided that the part of the longitudinal struts provided in the baking chamber is cooled. For this purpose it can optionally be provided that the cooling air introduced into the cooling duct only flows through the part of the longitudinal struts which is arranged in the baking chamber.

Furthermore, a heating of the cooling air is optionally made possible thereby. It is optionally provided to arrange a plurality of injection openings on the cooling duct. As a result, it is optionally possible to introduce cooling air into the cooling duct at different points. Preferably it is provided to arrange the at least one injection opening in the region of the pre-head or just behind the oven head.

Optionally it is provided that the longitudinal strut comprises a hollow profile, wherein the cooling duct is arranged in the hollow profile or the cooling duct is formed by the interior of the hollow profile.

As a result of this configuration, it is possible to arrange the cooling duct on the longitudinal strut or integrate it into the longitudinal strut. By using hollow profiles, it is possible to manufacture the longitudinal struts efficiently and simply.

Optionally it is provided that the baking chamber is configured to be substantially closed with the exception of the following openings: a vent opening for removing the gaseous media, in particular the combustion gases and the air, from the baking chamber, one or more feed openings for the fuel mixture, an inlet opening for the baking tong chain, an outlet opening for the baking tong chain and at least one convection opening.

A vent can optionally be provided at the vent opening for removing the gaseous media. The fuel mixture consists in particular of primary oxygen and fuel. Optionally it can be provided that the baking apparatus only comprises at least one convection opening, which lets the cooling air flow from the cooling duct of the at least one longitudinal strut to produce artificial convection horizontally through the baking chamber. Optionally however it can also be provided that the baking device comprises at least one convection opening which as feed opening for a convection gas stream comprises a further convection fan for improving the artificial convection in the baking chamber. This convection gas stream can comprise gaseous media, in particular air and/or recirculated baking chamber gas. Thus, in order to produce artificial convection it is possible to supply cooling air from the convection opening of a cooling duct of the at least one longitudinal strut and/or to supply a convection gas stream through a convection opening configured as a feed opening for a further convection fan. Due to the closed configuration of the baking device, it should be possible that no ambient air or only a small quantity of ambient air enters into the baking chamber.

Optionally it is provided that the convection fan is provided to blow in the cooling air used for cooling the cooling duct, in particular through the injection opening via which cooling air for producing artificial convection can be introduced into the baking chamber in a controlled and/or regulated manner, wherein the cooling air is introduced or can be introduced via injection openings in the cooling duct.

By means of the convection fan, it is possible to control and/or regulate the artificial convection in the baking chamber by the control and/or regulation of the convection fan. By this means cooling air optionally introduced into the cooling channel and therefore the cooling air exiting from the cooling duct through the convection opening can be controlled and/or regulated.

Optionally it is provided that the flow direction of the cooling air exiting from the at least one convection opening of the cooling duct of the at least one longitudinal strut runs contrary to the flow direction of the cooling air flowing in the cooling duct.

Since the flow direction in particular runs contrary to the flow direction of the cooling air flowing into the cooling channel, the convection, in particular the entrainment of heat and the mixing of the baking chamber gases is improved. Optionally it is provided that the flow direction of the exiting cooling air runs contrary to the direction of the main direction of movement of the baking tongs of the upper or lower transport plane and in particular runs horizontally.

Optionally it is provided that the longitudinal strut is or are configured as a vertical guide rail for guide rollers and/or that the longitudinal strut is or are configured as a lateral guide strip for lateral guide rollers.

By this means, the longitudinal struts configured as vertical guide rails for the guide rollers and/or as lateral guide strips for the lateral guide rollers can be cooled.

Optionally it is provided that the at least one longitudinal strut comprises a running rail acting as a running surface for the rollers.

Due to the running rail which acts as a running surface for the rollers, it is possible to make the parts not coming in contact with the rollers of inexpensive and less resistant materials. Preferably only the running rail is optionally made of a high-quality material, in particular of a high-strength steel, particularly preferably of DIN 174 1.1221 Ck 60 which is hardened and tempered. The longitudinal strut can optionally be formed of DIN 2395 St 44-3. Due to the cooling of the longitudinal strut, the running rail comprised by the longitudinal strut can be cooled.

Optionally it is provided that the at least one longitudinal strut is arranged on the baking apparatus frame and/or that the at least one longitudinal strut is part of the baking apparatus frame.

Preferably the longitudinal struts which are arranged on the baking apparatus frame and/or are part of the baking apparatus frame reinforce and/or stiffen the longitudinal struts. As a result, it is possible to partially dispense with other parts which reinforce and/or stiffen the baking apparatus. Thereby it is possible to manufacture the baking apparatus cost efficient and simple.

Optionally it is provided that a first fastening device is provided for connecting the longitudinal strut to a part of the baking apparatus frame, wherein the fastening device comprises an extension and a recess for fastening the extension.

By means of these features it is possible to fasten the longitudinal struts simply and efficiently on the baking device. As a result, the time expenditure and the risk of an error during fabrication are reduced considerably compared with conventional baking apparatuses. In particular, in conventional baking apparatuses, the longitudinal struts are welded to the baking apparatus frame. This conventional fastening of the longitudinal struts, in particular designed as L-profiles is very time-consuming and prone to error since the longitudinal struts are in particular aligned and welded on site with precise accuracy. Since such a conventional welding is not necessary in the baking apparatus, it is possible to substantially reduce the production costs and also the assembly time of the baking apparatus.

Optionally it is provided that the baking apparatus frame comprises in particular vertically running supports and/or is formed from in particular vertically running supports and that the at least one longitudinal strut is fastened or can be fastened to these supports via the at least one fastening device.

The longitudinal struts are preferably fastened by means of the fastening device to the in particular vertically running supports of the baking apparatus frame or can be fastened thereon. The baking apparatus frame can also be formed from the vertically running supports. In particular, it is provided that grooves are lasered into the supports which serve as fastening devices. The counter-pieces to the lasered grooves, in particular the tongues of the tongue-groove system form the fastening devices of the longitudinal struts. The running rails are arranged on the longitudinal struts according to this embodiment, in particular screwed on. By this means, the position of the longitudinal struts on the baking apparatus frame can be fixed before assembly, with the result that the assembly costs and the time required for assembly are substantially reduced.

Optionally it is provided that the path along which the baking tong chain circulates successively comprises an upper substantially horizontally running transport plane, a rear deflection region in the region of the rear deflection point, a lower substantially horizontally running transport plane and a front deflection region in the region of the front deflection point, that the baking tong chain is guided in the rear deflection region by deflection about 180° from the upper transport plane to the lower transport plane, that the baking tong chain is guided in the front deflection region by deflection about 180° from the lower transport plane back again to the upper transport plane and that the transport planes comprise at least two longitudinal struts or are formed from at least two longitudinal struts.

In the baking apparatus preferably an upper and a lower transport plane are provided, which each comprise at least two longitudinal struts or are formed from at least two longitudinal struts.

Optionally it is provided that that the longitudinal struts are made of solid metal, in particular steel.

The longitudinal struts can furthermore be formed of steel or stainless steel.

Optionally it is provided that the baking tongs of the baking tong chain of the baking apparatus each successively run through a baking mass application region for application of a baking mass to an opened baking tong, a closing region for closing the baking tongs, the baking chamber for baking the baked products in the closed baking tongs in which at least one heating arrangement is provided for heating the baking tongs located in the baking chamber, an opening region for opening the baking tongs and a baked product removal region for removing the baked products from the opened baking tongs, wherein the baking tong chain is deflected at a rear deflection point arranged in the baking chamber and at a front deflection point arranged in a pre-head remote from the baking chamber, wherein the baking chamber is configured as a substantially closed baking chamber with a heat insulation.

### BRIEF DESCRIPTION OF THE DRAWINGS

Further features according to the invention are obtained from the claims, the description of the exemplary embodiments and the figures.

The invention is now explained in detail for the example of exemplary non-exclusive exemplary embodiments.

FIG. 1 shows a schematic side view or sectional view of a first embodiment of a baking apparatus according to the invention.

FIG. 2 shows a perspective view of a second embodiment of a baking apparatus according to the invention.

FIG. 3 shows a schematic two-dimensional sectional view through a third embodiment of a baking apparatus according to the invention.

### DETAILED DESCRIPTION

Unless specified differently, the reference numbers correspond to the following components: baking apparatus 1, baking chamber 2, baking tong chain 3, pre-head 4, front deflection point 5, rear deflection point 6, baking tong carriage 7, baking tongs 8, rollers 9, longitudinal strut 10, cooling duct 11, convection opening 12, vent opening 13, feed opening 14, inlet opening (for the baking tong chain) 15, outlet opening (for the baking tong chain) 16, injection opening 17, running rail 18, heating arrangement 19, baking apparatus housing 20, baking apparatus frame 21, supports 22, upper transport plane 23, lower transport plane 24, convection fan 25.

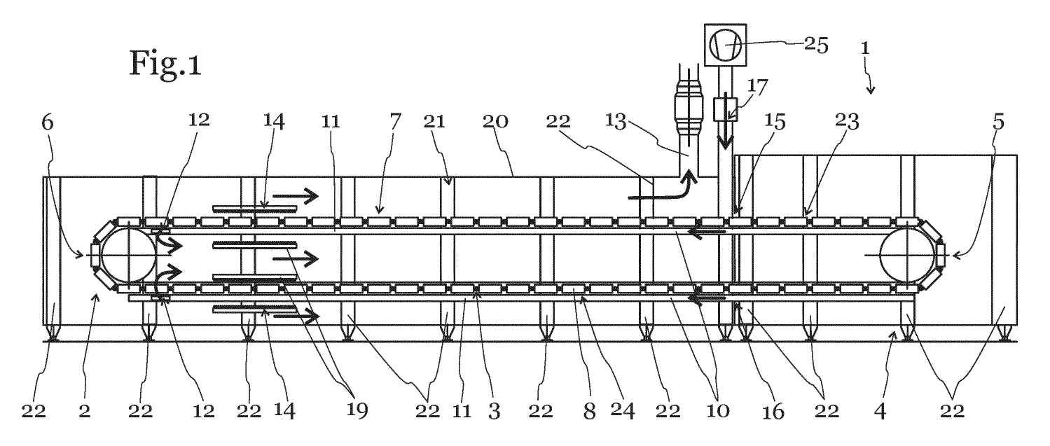

FIG. 1 shows a schematic side view or sectional view of a first embodiment of a baking apparatus 1. The baking apparatus 1 comprises a baking apparatus frame 21 with a baking apparatus housing 20. A baking chamber 2 is arranged inside the baking apparatus housing 20. The baking apparatus 1 comprises an endless baking tong chain 3 which circulates continuously along an inherently closed path and moves through the baking chamber 2. This baking tong chain 3 extends from a front deflection point 5 arranged in a pre-head 4 to a rear deflection point 6. The baking tong chain 3 comprises intercoupled baking tong carriages 7 with openable and closable, in particular fold-out and fold-in baking tongs 8. A plurality of rollers 9 which are not shown in this figure are provided on the baking tong chain 3 and which roll along at least a part of the path and on four longitudinal struts 10 to support and/or guide the baking tong chain 3.

Cooling ducts 11 through which cooling air flows, which are arranged inside the longitudinal struts 10, are provided to cool these longitudinal struts 10. The cooling ducts 11 open in the region of the rear deflection point 6 through respectively one convection opening 12 into the baking chamber 2. In this embodiment four convection openings 12 are provided in the region of the rear deflection point 6. Furthermore, a fan 25 is provided in this embodiment for generating a convection flow in the baking chamber 2 and for conveying the cooling air through the cooling ducts 11. The cooling air is introduced by the convection fan 25 through the injection openings 17 into the cooling duct 11. The injection openings 17 are arranged at a distance from the convection openings 12. In this embodiment the injection openings 17 are arranged in the proximity of the dividing wall between pre-head 4 and the baking chamber 2 and in the region of a vent opening 13. In a further embodiment not shown, the injection openings 17 can also be arranged in the vicinity of the front deflection point 5 and/or in the region of the pre-head 4 and/or in the region of the vent opening 13 and/or in the region of the baking chamber 2. In this embodiment the fan 25 introduces the cooling air into the injection openings 17 of the cooling ducts 11 via a support 22 of the baking apparatus frame 21 in the region of the dividing wall between pre-head 4 and the baking chamber 2. In an embodiment not shown the fan 25 introduces the cooling air into the injection openings 17 of the cooling ducts 11 in the vicinity of the front deflection point 5 and/or in the region of the pre-head 4 and/or in the region of the vent opening 13 and/or in the region of the baking chamber 2. The cooling air which exits through the convection openings 12 from the cooling ducts 11 of the longitudinal struts 10 is additionally used to produce an artificial convection and flows, in particular horizontally, through the baking chamber 2. In this embodiment it is provided that the cooling ducts 11 extend substantially closed on the baking chamber side as far as the convection opening 12 thereof in the region of the rear deflection point 6 through the baking chamber 2. This means in particular that the cooling air introduced into the cooling ducts 11 can only flow from the convection openings 12 from the cooling ducts 11 into the baking chamber 2. As a result, the cooling ducts 11 act as heat exchangers and the cooling air can enter into the baking chamber 2 as pre-heated convection air. As a result of this synergistic effect of the baking apparatus 1, the energy consumption of the baking apparatus 1 is reduced. It is thereby possible to operate the baking apparatus 1 more efficiently, in particular more energy-efficiently. Furthermore, the temperature of the longitudinal struts 10 is reduced by up to 30° C. by the cooling with the cooling air. As a result, with the baking apparatus 1 it is possible to increase the lifetime of the rollers 9 not shown and/or the bearings thereof. Due to these synergistic effects the baking apparatus 1 can be operated more efficiently and furthermore has a longer lifetime.

In this embodiment, the baking chamber 2 of the baking apparatus 1 is configured to be substantially closed. The baking chamber 2 of the baking apparatus 1 of this first embodiment has a vent opening 13 for removing the gaseous media, in particular the combustion gases and the air from the baking chamber 2, a plurality of feed openings 14 for the fuel mixture, an inlet opening 15 for the baking tong chain 3, an outlet opening 16 for the baking tong chain 3 and in this embodiment four convection openings 12. The convection fan 25 is provided for blowing cooling air which flows through the cooling duct 11 for cooling through the injection openings 17 into the cooling ducts 11. By means of the convection fan 25 cooling can be introduced into the baking chamber 2 in a controlled and/or regulated manner to produce artificial convection. The flow direction of the cooling air exiting from the convection openings 12 of the cooling ducts 11 of the longitudinal struts 10 runs contrary to the flow direction of the cooling air flowing in the cooling ducts 11. By this means the heat transfer to the cooling ducts 11 can be improved. In this first embodiment of the baking apparatus 1, the flow direction of the exiting cooling air also flows contrary to the main direction of motion of the baking tongs 8 of the upper transport plane 23 and in particular horizontally.

In the embodiment of FIG. 1 the longitudinal struts 10 are arranged on the baking apparatus frame 21. The baking apparatus frame 21 comprises vertically running supports 22. The longitudinal struts 10 are fastened or can be fastened by means of fastening devices to these supports 22 of the baking apparatus frame 21. As a result, the longitudinal struts 10 can be arranged or can be attached simply and rapidly to the baking apparatus 1, in particular to the baking apparatus frame 21. In this embodiment of the baking apparatus 1 the longitudinal struts 10 act as reinforcement and/or stiffening of the baking apparatus frame 21 and the baking apparatus 1.

In this embodiment the baking tong chain 3 runs along its path successively through an upper substantially horizontally running transport plane 23, a rear deflection region in the region of the rear deflection point 6, a lower substantially horizontally running transport plane 24 and a front deflection region in the region of the front deflection point 5. The baking tong chain 3 is guided in the rear deflection region by deflection about 180° from the upper transport plane 23 onto the lower transport plane 24. The baking tong chain 3 is guided in the front deflection region by deflection about 180° from the lower transport plane 24 back again to the upper transport plane 23. In this embodiment the transport planes 23 and 24 each comprise two longitudinal struts 10. In this embodiment the longitudinal struts 10 are made of solid metal, in particular of steel.

The baking tongs 8 of the baking tong chain 3 of the baking apparatus 1 each run successively through a baking mass application region for applying a baking mass to an opened baking tong 8, a closing region for closing the baking tong 8, the baking chamber 2 for baking the baked products in the closed baking tongs 8, an opening region for opening the baking tongs 8 and a baked product removal region for removing the baked products from the opened baking tongs 8. In the baking chamber 2 heating arrangements 19 are provided for heating the baking chamber 2 or the baking tongs 8 located in the baking chamber 2.

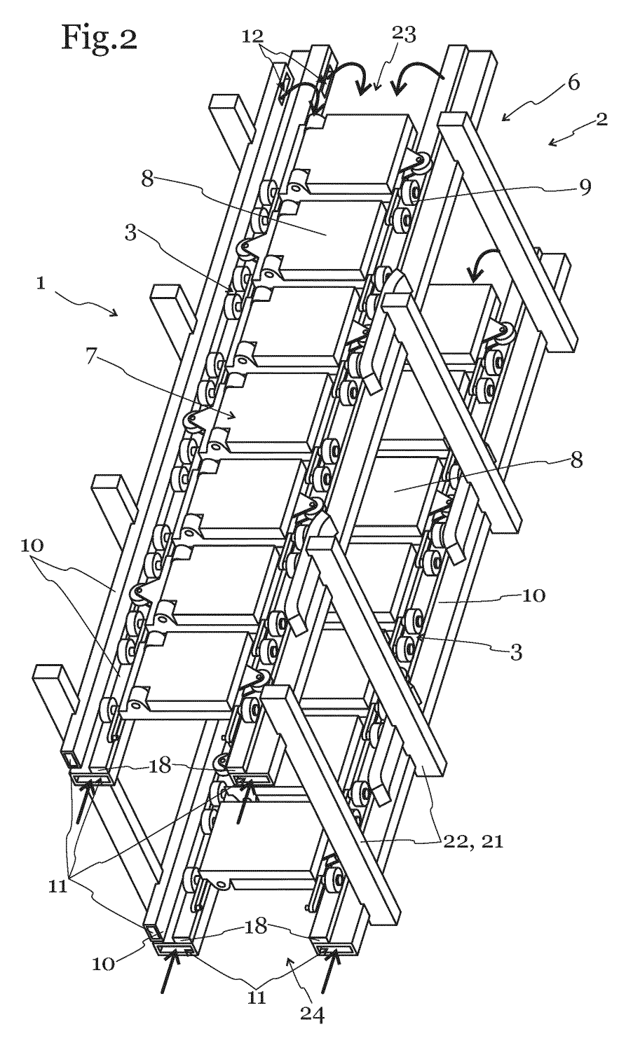

FIG. 2 shows a perspective view of a second embodiment of a baking apparatus 1, wherein the construction of FIG. 2 can also be a part of the construction of FIG. 1. In this figure the upper transport plane 23 and the lower transport plane 24 of the baking apparatus 1 are shown in perspective view. The baking apparatus 1 has an endless baking tong chain 3 which circulates continuously along an inherently closed path and moves through the baking chamber 2. The baking tong chain 3 comprises intercoupled baking tong carriages 7 with openable and closable, in particular fold-out and fold-in baking tongs 8. A plurality of rollers 9 are provided on the baking tong chain 3 which roll along at least a part of the path on at least one longitudinal strut 10 to support and/or guide the baking tong chain 3. In this embodiment the longitudinal struts 10 are configured as vertical guide rails for the running rollers and as lateral guide strips for the lateral guide rollers.

According to an alternative embodiment, the lateral guide strips can also be omitted.

Cooling ducts 11 through which cooling air flows are provided for cooling the longitudinal struts 10. The cooling ducts 11 open into the baking chamber 2 through convection openings 12 in the region of the rear deflection point 6. The cooling air exiting through the convection openings 12 from the cooling ducts 11 of the longitudinal struts 10 is used to produce an artificial convection which in particular flows horizontally through the baking chamber 2. In this embodiment it is provided that the cooling ducts 11 extend as far as the convection openings 12, in particular on the baking chamber side, in a closed manner through the baking chamber 2. Furthermore it is provided that the longitudinal struts 10 comprise hollow profiles, wherein the cooling ducts 11 are formed by the interior of the hollow profile. As a result, the longitudinal struts 10 in this embodiment of the baking apparatus 1 can be produced simply and cost-effectively.

The flow direction of the cooling air exiting from the convection openings 12 of the cooling ducts 11 of the longitudinal struts 10 in the baking chamber runs contrary to the flow direction of the cooling air flowing in the cooling ducts 11. The longitudinal struts 10 comprise running rails 18 acting as a running surface for the rollers 9. As a result of the cooling of the longitudinal struts 10, the running rails 18 arranged thereon are also cooled. The longitudinal struts 10 are arranged on the baking apparatus frame 21. A first fastening device is provided for connection of the longitudinal struts 10 to a part of the baking apparatus frame 21. In this embodiment this fastening device comprises an extension and a recess for fastening the extension. The baking apparatus frame 21 comprises vertically running supports 22. The longitudinal struts 10 are fastened to these supports 22 via the fastening device. By this means, the longitudinal struts 10 can be arranged or attached simply and quickly on the baking apparatus 1, in particular on the baking apparatus frame 21. In this embodiment of the baking apparatus 1, the longitudinal struts 10 are also used as reinforcement and/or stiffening of the baking apparatus frame 21 and therefore of the baking apparatus 1.

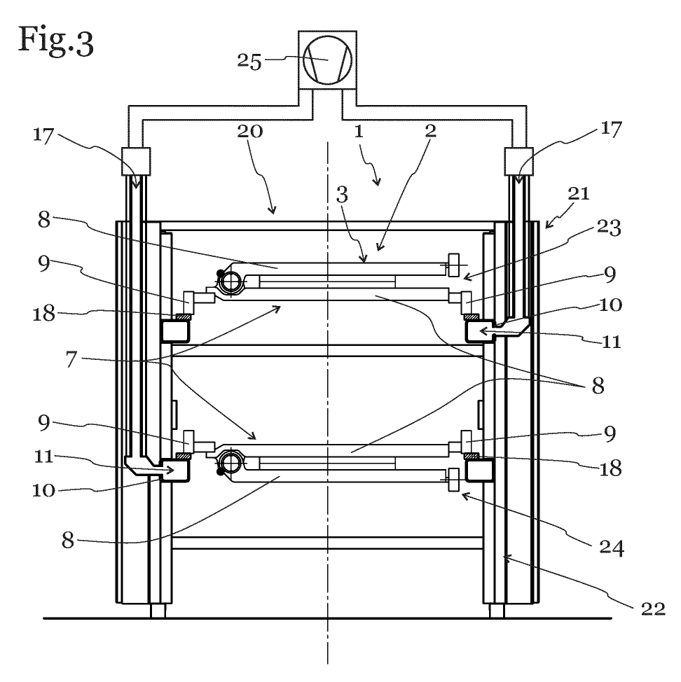

FIG. 3 shows a schematic two-dimensional section view through a third embodiment of a baking apparatus 1, wherein the construction of FIG. 3 can also be part of the constructions of FIG. 1 and/or FIG. 2. The baking apparatus 1 comprises a baking apparatus housing 20 and a baking apparatus frame 21. The longitudinal struts 10 are arranged on vertically running supports 22 of the baking apparatus frame 21. An endless baking tong chain 3 which circulates continuously along an inherently closed path and moves through the baking chamber 2 is provided in the baking chamber 2 of the baking apparatus 1. The baking tong chain 3 comprises intercoupled baking tong carriages 7 with openable and closable, in particular fold-out and fold-in baking tongs 8. A plurality of rollers 9 are provided on the baking tong chain 3. The rollers 9 are used to support and/or guide the baking tong chain 3 and roll along at least a part of the path on the four longitudinal struts 10. A cooling duct 11 through which cooling air flows is provided for cooling the longitudinal struts 10. The convection fan 25 is used to blow in the cooling air required for cooling the cooling duct 11. The cooling air is introduced by the convection fan 25 through injection openings 17 into the cooling ducts 11. In this embodiment a convection fan 25 is provided which introduces cooling air into two cooling ducts 11. However, it can also be provided that a convection fan 25 introduces cooling air into more than two, in particular four, cooling ducts 11. Furthermore, in other embodiments it can be provided that each cooling duct 11 has at least one dedicated convection fan 25. Running rails 18 are arranged on the longitudinal struts 10, which act as running surfaces for the rollers 9. In this embodiment it is shown that the injection openings 17 for introducing the cooling air into the cooling ducts 11 can be arranged at different positions on the baking apparatus 1. In this embodiment, it is provided that respectively one injection opening 17 for a cooling duct 11 of the upper 23 and lower transport plane 24 is arranged in two opposite supports 22 of the baking apparatus frame 21. Located at a distance from these injection openings 17 in the same support 22 are two further injection openings 17 for the cooling ducts 11 not yet provided with injection openings 17 in this two-dimensional sectional view.

In an embodiment not shown it can be provided that the injection openings 17 for the cooling ducts 11 are arranged in spaced-apart supports 22 of the baking apparatus frame 21. As a result, it is optionally possible to introduce the cooling air into the cooling ducts 11 at different positions of the baking apparatus 1. Furthermore, it is optionally provided that cooling air at different temperature is introduced into the cooling ducts 11. In an embodiment not shown it can be provided that a plurality of, in particular spaced-apart, injection openings 17 can be provided for introducing cooling air into a cooling duct 11.

In an embodiment not shown it can be provided that cooling air is introduced in each case through a common injection opening 17 into the cooling ducts 11 of the upper 23 and lower transport plane 24 on one side.

1-15. (canceled)

16. Baking apparatus (1) for producing baked edible products, comprising:
a baking apparatus frame (21) with a baking apparatus housing (20) and a baking chamber (2) arranged inside the baking apparatus housing (20);
an endless baking tong chain (3) which circulates continuously along an inherently closed path and moves through the baking chamber (2), the chain extending from a front deflection point (5) arranged in a pre-head (4) to a rear deflection point (6), the baking tong chain (3) comprising coupled-together baking tong carriages (7) with openable and closable fold-out and fold-in baking tongs (8) and a plurality of rollers (9);
at least one longitudinal strut (10) that supports and/or guides the baking tong chain (3), wherein the rollers (9) roll at least along a part of the path on the at least one longitudinal strut;
a cooling duct (11) through which cooling air flows and which cools the at least one longitudinal strut (10), wherein the cooling duct (11) defines at least one convection opening (12) located exclusively in the region of the rear deflection point (6) that opens into the baking chamber (2); and
a convection fan (25) that generates a convection flow in the baking chamber (2) and conveys the cooling air through the cooling duct (11) so that the cooling air flows through the convection opening (12) from the cooling duct (11) of the at least one longitudinal strut (10) to produce an artificial convection through the baking chamber (2).

17. The baking apparatus (1) according to claim 16, wherein cooling duct extends closed through the baking chamber with the at last one convection opening (12) located at or near the end of the cooling duct (11) in the baking chamber (2).

18. The baking apparatus (1) according to claim 16, wherein the convection fan (25) introduces the cooling air through at least one injection opening (17) into the cooling duct (11), and the at least one injection opening (17) or at least one injection opening (17) is provided at a distance from the convection opening (12).

19. The baking apparatus (1) according to claim 16, wherein the convection fan (25) introduces the cooling air through at least one injection opening (17) into the cooling duct (11), and the at least one injection opening (17) or at least one injection opening (17) is provided in one or more regions selected from (i) the region of the front deflection point (5), (ii) the region of the pre-head (4), (iii) the region of a vent opening (13), (iv) the region of a dividing wall between pre-head (4) and the baking chamber (2), (v) the region of the baking chamber (2).

20. The baking apparatus (1) according to claims 16, wherein the at least one longitudinal strut (10) comprises a hollow profile, wherein the cooling duct (11) is arranged in the hollow profile or the cooling duct (11) is formed by the interior of the hollow profile.

21. The baking apparatus (1) according to claim 16, wherein the baking chamber (2) is configured to be substantially closed with the exception of a vent opening (13) for removing gaseous media from the baking chamber (2), one or more feed openings (14) for a fuel mixture, an inlet opening (15) for the baking tong chain (3), an outlet opening (16) for the baking tong chain (3), and at least one convection opening (12).

22. The baking apparatus (1) according to claim 16, wherein cooling air for producing artificial convection is introduced into the baking chamber (2) in a controlled and/or regulated manner via the convection fan (25), wherein the cooling air is introduced via injection openings (17) in the cooling duct (11).

23. The baking apparatus (1) according to claim 16, wherein the flow direction of the cooling air exiting from the at least one convection opening (12) of the cooling duct (11) of the at least one longitudinal strut (10) runs counter to the flow direction of the cooling air flowing in the cooling duct (11).

24. The baking apparatus (1) according to claim 16, wherein the at least one longitudinal strut (10) is configured as a vertical guide rail for guide rollers and/or the at least one longitudinal strut (10) configured as a lateral guide strip for lateral guide rollers.

25. The baking apparatus (1) according to claim 16, wherein the at least one longitudinal strut (10) comprises a running rail (18) acting as a running surface for the rollers (9).

26. The baking apparatus (1) according to claim 16, wherein the at least one longitudinal strut (10) is arranged on the baking apparatus frame (21) and/or is part of the baking apparatus frame (21).

27. The baking apparatus (1) according to claim 16, wherein a first fastening device is provided for connecting the longitudinal strut (10) to a part of the baking apparatus frame (21), wherein the fastening device comprises an extension and a recess for fastening the extension.

28. The baking apparatus (1) according to claim 27 wherein the baking apparatus frame (21) comprises vertically running supports (22) and/or is formed from in particular vertically running supports (22), and that the at least one longitudinal strut (10) is fastened to these supports (22) via the at least one fastening device.

29. The baking apparatus (1) according to claim 16 wherein the path along which the baking tong chain (3) circulates successively comprises an upper substantially horizontally running transport plane (23), a rear deflection region in the region of the rear deflection point (6), a lower substantially horizontally running transport plane (24) and a front deflection region in the region of the front deflection point (5).

30. The baking apparatus (1) according to claim 29, wherein the baking tong chain (3) is guided in the rear deflection region by deflection about 180° from the upper transport plane (23) to the lower transport plane (24), the baking tong chain (3) is guided in the front deflection region by deflection about 180° from the lower transport plane (24) back again to the upper transport plane (23) and the transport planes (23, 24) comprise or are formed from at least two of said longitudinal struts (10).

31. The baking apparatus (1) according to claim 16, wherein the longitudinal struts (10) are made of solid metal.

32. The baking apparatus (1) according to claim 16, wherein the longitudinal struts (10) are made of steel.

33. The baking apparatus (1) according to claim 16, wherein the baking tongs (8) of the baking tong chain (3) of the baking apparatus (1) each successively run through a baking mass application region for application of a baking mass to an opened baking tong (8), a closing region for closing the baking tongs (8), the baking chamber (2) for baking the baked products in the closed baking tongs (8) in which at least one heating arrangement (19) is provided for heating the baking tongs (8) located in the baking chamber (2), an opening region for opening the baking tongs (8), and a baked product removal region for removing the baked products from the opened baking tongs (8).

34. The baking apparatus (1) according to claim 33, wherein the baking tong chain (3) is deflected at a rear deflection point (6) arranged in the baking chamber (2) and at a front deflection point (5) arranged in a pre-head (4) remote from the baking chamber (2), wherein the baking chamber (2) is configured as a substantially closed baking chamber (2) with a heat insulation.

35. The baking apparatus (1) according to claim 16, wherein said artificial convection through the baking chamber (2) generated by said convection fan (25) is an artificial horizontal convection.
